(19) United States
(12) Patent Application Publication
(10) Pub. No.: US 2014/0012979 A1
(43) Pub. Date: Jan. 9, 2014

(54) METHOD OF MONITORING REMOTE ACCESS PROCESS AND CONTROLLED APPARATUS

(71) Applicant: RSUPPORT CO., LTD., Seoul (KR)

(72) Inventor: Hyung Su SEO, Yangpyeong-gun (KR)

(73) Assignee: RSUPPORT CO., LTD., Seoul (KR)

(21) Appl. No.: 13/688,610

(22) Filed: Nov. 29, 2012

(30) Foreign Application Priority Data
Jul. 3, 2012 (KR) 10-2012-0072170

(51) Int. Cl. H04L 29/08

(52) U.S. Cl. CPC H04L 67/36
USPC 709/224

(57) ABSTRACT

Provided are a method of monitoring a remote access process and a controlled apparatus whereby efficiency in remote control work can be improved. The method includes executing a downloaded access file, running an application for remote access through execution of the access file and capturing an entire interface screen of a controlled apparatus showing a remote access process at predetermined periods as soon as the application is run, and transmitting the captured screen and identification information for identifying the controlled apparatus to a web server through hypertext transfer protocol (HTTP). Accordingly, even before remote access is completed, an administrator can continuously monitor a remote access process to a user terminal through an administrator terminal on the basis of a captured screen as if remote access was complete.

### CLAIM FOR PRIORITY

This application claims priority to Korean Patent Application No. 10-2012-0072170 filed on Jul. 3, 2012 in the Korean Intellectual Property Office (KIPO), the entire contents of which are hereby incorporated by reference.

### BACKGROUND

1. Technical Field

Example embodiments of the present invention relate in general to remote support technology, and more particularly, to a method of monitoring a remote access process and a controlled apparatus.

2. Related Art

As technology for remotely accessing and controlling a personal computer (PC) that is located at or distributed over a long distance, PC remote control enables remote use of a user's PC via the Internet. PC remote control makes it possible to use all functions of a remote user's PC as they are through a computer connected with the Internet while looking at a screen.

Due to such convenience, remote control has actually been disseminated to personal users as well as company users. Remote control tools are not only used for monitoring and managing user PCs in companies, but are also being increasingly used for personal users to control their PCs in their homes from their companies and in their companies from their homes.

Meanwhile, to remotely control a user terminal, an administrator should cause the user terminal to run a program for remote access and thereby gain remote access.

However, when the user terminal fails to execute an access file for remote access due to a fire wall, etc., an administrator cannot determine failure reason of the remote access.

### SUMMARY

Accordingly, example embodiments of the present invention are provided to substantially obviate one or more problems due to limitations and disadvantages of the related art.

Example embodiments of the present invention provide a method of monitoring a remote access process in which a remote access process of a user is monitored, and thereby efficiency in remote control work can be improved.

Example embodiments of the present invention also provide a remote access process monitoring system that performs the method of monitoring a remote access process.

In some example embodiments, a method of monitoring a remote access process performed in a controlled apparatus includes: executing a downloaded access file; running an application for remote access through execution of the access file, and capturing an entire interface screen of the controlled apparatus showing a connection process at predetermined periods as soon as the application is run; and transmitting the captured screen and identification information for identifying the controlled apparatus to a web server through hypertext transfer protocol (HTTP).

Here, transmitting the captured screen and the identification information to the web server through HTTP may include, when remote access from a control apparatus is completed, stopping transmission of the captured screen and the identification information for identifying the controlled apparatus to the web server through HTTP.

In other example embodiments, a method of monitoring a remote access process performed in a control apparatus includes: accessing a gateway and waiting for remote access to a controlled apparatus; while waiting for the remote access, transmitting identification information about the controlled apparatus to a web server, and requesting a capture screen of the controlled apparatus corresponding to the identification information; and receiving the capture screen from the web server and displaying the received capture screen.

Here, the capture screen may be an interface screen of the controlled apparatus obtained by screen-capturing the process before the remote access to the controlled apparatus is completed at predetermined periods.

In other example embodiments, a controlled apparatus includes: a processor configured to execute a downloaded access file, and capture an entire interface screen of the controlled apparatus, which shows at least one of a network authentication process and a remote access module download process for remote access from a control apparatus, at predetermined periods through execution of the access file; and a communicator configured to transmit the captured screen and an identifier for identifying the controlled apparatus to a web server through HTTP on the basis of control of the processor.

Here, when remote access from the control apparatus is completed, the processor may stop transmitting the captured screen and the identifier for identifying the controlled apparatus to the web server through HTTP.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a system for monitoring a remote access process according to an example embodiment of the present invention;

FIG. 2 is a flowchart illustrating a method of monitoring a remote access process according to an example embodiment of the present invention;

FIG. 3 is an administrator interface screen showing a situation after authentication of an administrator terminal shown in FIG. 2 is performed;

FIG. 4 shows a capture screen of a user terminal displayed on the administrator terminal shown in FIG. 2;

FIG. 5 shows a screen of a user terminal displayed on the administrator terminal shown in FIG. 2 after execution of an access file is finished;

FIG. 6 is a user interface screen showing a process before an access file of the user terminal shown in FIG. 2 is executed;

FIG. 7 is a user interface screen showing a capture screen when an access file of the user terminal shown in FIG. 2 is executed;

FIG. 8 is a user interface screen after execution of an access file of the user terminal shown in FIG. 2 is finished;

FIG. 9 is a flowchart illustrating a method for an administrator terminal to monitor a remote access process according to an example embodiment of the present invention;

FIG. 10 is a flowchart illustrating a method for a user terminal to monitor a remote access process; and

FIG. 11 is a block diagram showing a constitution of a user terminal according to an example embodiment of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, example embodiments of the present invention will be described in detail with reference to the accompanying drawings. To facilitate overall understanding of the present invention, like numbers refer to like elements throughout the description of the figures, and the description of the same component will not be reiterated.

In an example embodiment of the present invention below, an administrator terminal 100 and a user terminal 200 may not only be desktop computers but also various digital information processing devices such as laptop computers, palmtop computers, ultra mobile personal computers (UMPCs), tablet PCs, personal digital assistants (PDAs), web pads, cellular phones, and smart phones.

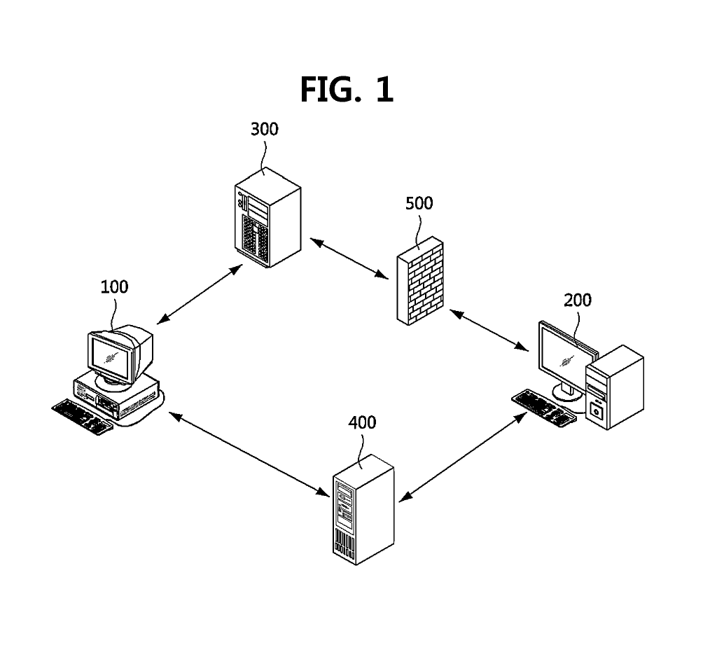

FIG. 1 is a conceptual diagram illustrating a system for monitoring a remote access process according to an example embodiment of the present invention.

Referring to FIG. 1, a system for monitoring a remote access process according to an example embodiment of the present invention may include an administrator terminal 100, a user terminal 200, an authentication server 300, and a web server 400.

The administrator terminal 100 finishes authentication through the authentication server 300, is given an identifier, whereby the administrator terminal 100 and the user terminal 200 can be identified, by the authentication server 300 or the web server 400, and then waits for a connection with the user terminal 200.

Also, the administrator terminal 100 requests a capture file, in which an access file execution process of the user terminal 200 corresponding to the identifier is captured, from the web server 400, and receives the capture file, in which the access file execution process of the user terminal 200 is captured, from the web server 400 in real time.

The user terminal 200 accesses the authentication server on the basis of a user input, inputs identification information (e.g., a user name and an access number), and then is given the same identifier as given to the administrator terminal 100 by the authentication server 300.

Also, the user terminal 200 downloads an access file from the authentication server 300 on the basis of control of a user, and executes the downloaded access file.

Further, the user terminal 200 downloads the access file from the authentication server 300, and installs an application for remote access by executing the downloaded access file.

Here, installation of the application for remote access may include a process required for remote control (e.g., network authentication, and downloading and execution of a remote access module) before remote access.

As soon as the application for remote access is installed, the user terminal 200 captures a user interface screen showing a remote connection process, and transmits the captured screen to the web server 400 through hypertext transfer protocol (HTTP) using the identifier given by the authentication server 300 as a separator.

An example in which a user interface screen showing an access process of the administrator terminal 100 is captured through execution of an access file and transmitted to the web server 400 has been described in an example embodiment of the present invention.

However, in another example embodiment of the present invention, information showing the access process of the administrator terminal 100 in another form may be acquired through execution of an access file and transmitted to the web server 400.

When an identity (ID) and a password received from the administrator terminal 100 correspond to an ID and a password stored in advance, the authentication server 300 transmits a uniform resource locator (URL) and an access number to be provided to the user and an Internet protocol (IP) address and port information about a gateway server (not shown) that will establish a connection with the user terminal 200 to the administrator terminal 100.

Also, when an access number received from the user terminal 200 corresponds to a name and an access number stored in advance, the authentication server 300 determines that authentication has been completed, and transmits the access file and session information (an IP address, port information, etc.) about the gateway server (not shown), which can exchange data with the administrator terminal 100, to the user terminal 200.

Here, the user terminal 200 may download and install a remote access module through execution of the access file, and actually execute the remote access module (check of a connection environment such as network authentication) before remote access is completed. Also, the user terminal 200 screen-captures a process of downloading and installing the remote access module after execution of the access file and actually executing the remote access module before completion of remote access, compresses the capture file, and transmits the compressed capture file to the web server 400 through HTTP.

The web server 400 receives the identifier and the capture file in which the access file execution process is captured from the user terminal 200, and stores the received identifier and capture file. When an identifier corresponding to the identifier is received from the administrator terminal 100, the web server 400 transmits the capture file of the user terminal 200 corresponding to the identifier to the administrator terminal 100.

Here, the web server 400 may receive the capture file from the user terminal 200 through HTTP. Also, the web server 400 may be included in the gateway server (not shown) that relays data exchange between the administrator terminal 100 and the user terminal 200.

In the system for monitoring a remote access process according to an example embodiment of the present invention, when remote access to the user terminal 200 by executing an access file fails due to a firewall 500, an administrator can monitor a current state of the user terminal 200 through a capture screen even before a remote connection is established.

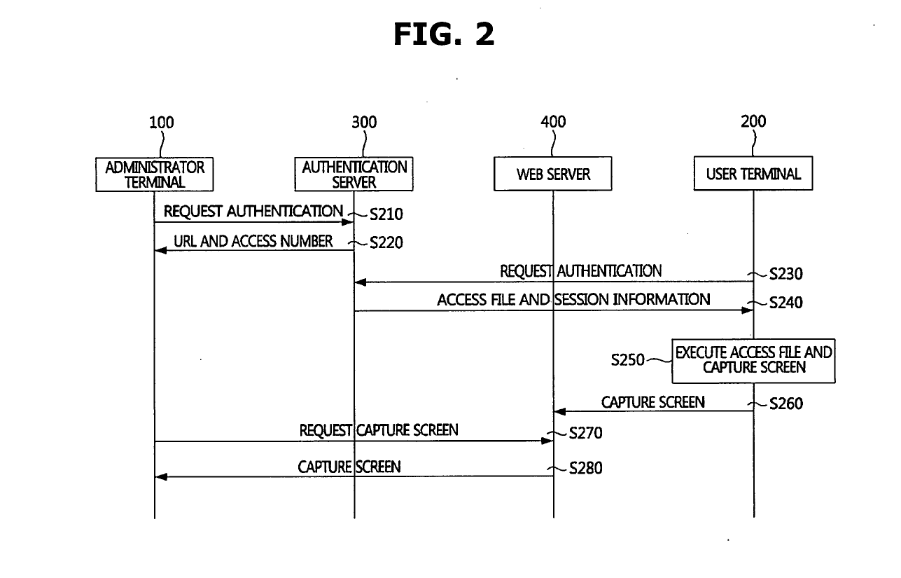

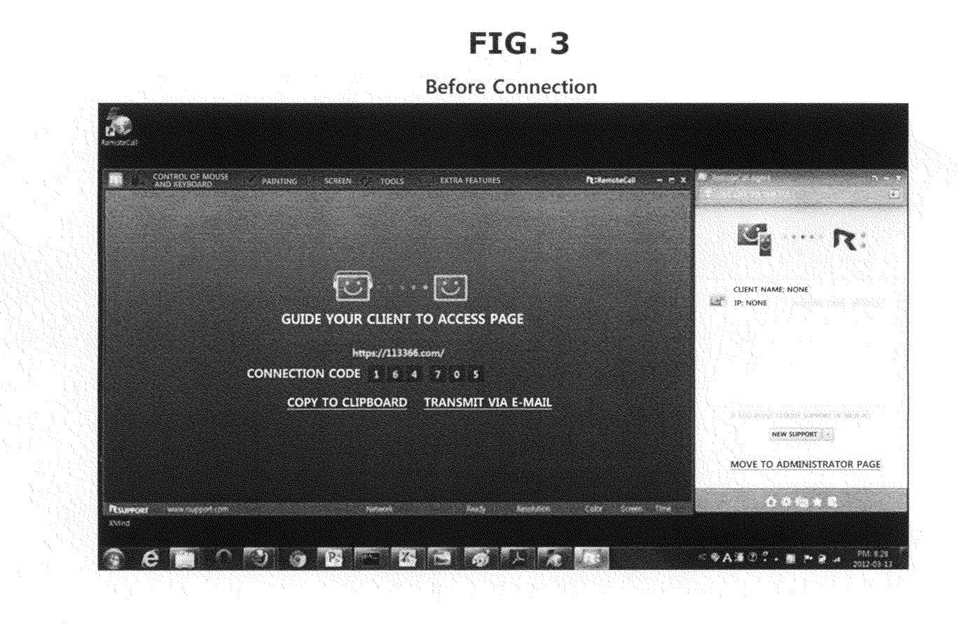

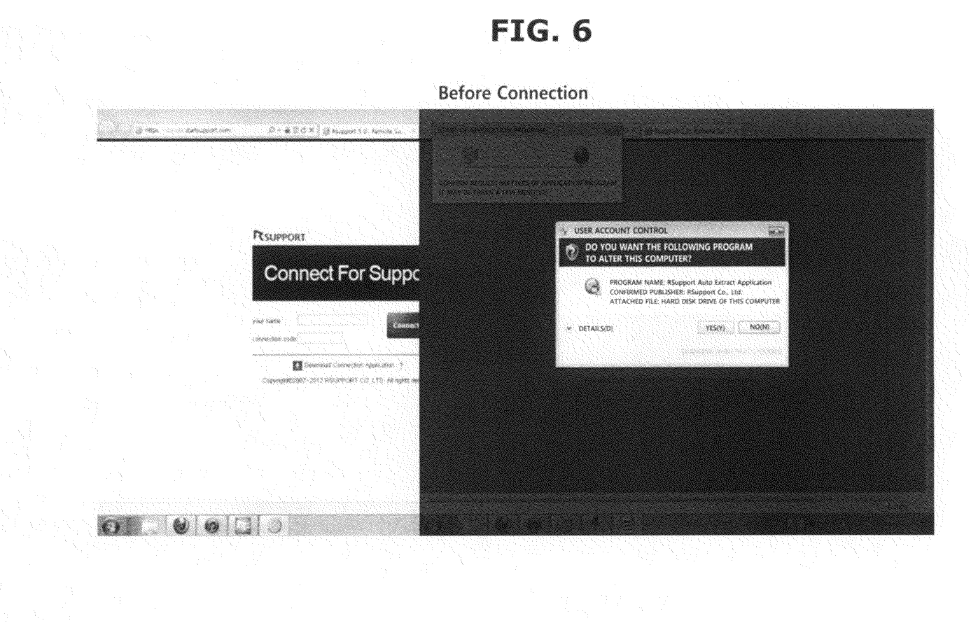

FIG. 2 is a flowchart illustrating a method of monitoring a remote access process according to an example embodiment of the present invention. FIG. 3 to FIG. 5 show administrator interface screens of an administrator terminal shown in FIG. 2. FIG. 6 to FIG. 8 show user interface screens of a user terminal shown in FIG. 2.

Referring to FIG. 2 to FIG. 8, an administrator terminal 100 runs a remote control program, and provides administrator identification information (e.g., an ID and a password) to an authentication server 300 on the basis of an administrator input signal (S210).

When the administrator identification information input from the administrator terminal 100 corresponds to identification information stored in advance, the authentication server 300 transmits a URL and an access number to be provided to a user and an IP address and port information about a gateway server (not shown) for a connection with a user terminal 200 to the administrator terminal 100 (S220).

When step 220 is performed by the authentication server 300, as shown in FIG. 3, a URL and an access number to be provided to a user may be checked through an interface of the administrator terminal 100, and whether or not the administrator terminal 100 has accessed the user terminal 200 may also be checked through the interface of the administrator terminal 100.

The user terminal 200 accesses the authentication server 300 on the basis of a user input signal, and provides user identification information (e.g., a user name and an access number) (S230).

Subsequently, when the user identification information input from the user terminal 200 corresponds to identification information stored in advance, the authentication server 300 determines that authentication between the user terminal 200 and the administrator terminal 100 has been completed.

When it is determined that authentication has been completed, the authentication server 300 transmits an access file and session information (an IP address, port information, etc.) about a gateway server, which will exchange data with the administrator terminal 100, to the user terminal 200 (S240).

At this time, the user terminal 200 may download and install a remote access module through execution of the access file, and actually execute the remote access module (check of a connection environment such as network authentication) before remote access is completed. Also, the user terminal 200 screen-captures a process of downloading and installing the remote access module after execution of the access file and actually executing the remote access module before completion of remote access, compresses the capture file, and transmits the compressed capture file and identification information about the user terminal 200 to the web server 400 through HTTP.

Referring to FIG. 6, an interface screen of the user terminal 200 shows a screen to which a user name (your name) and an access number (connection code) for access to the authentication server 300 can be input, and a screen interface that asks a user whether or not to download and execute an access file.

The user terminal 200 downloads the access file on the basis of a user input signal, captures an access file execution process, and transmits the capture file and the identification information (e.g., an access number) about the user terminal 200 to the web server 400 (S260).

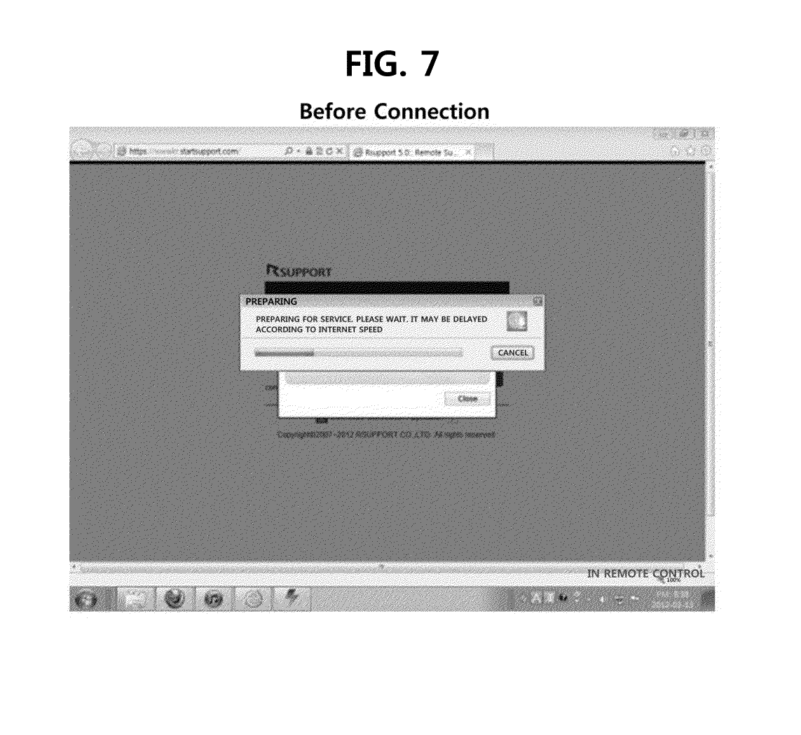

Referring to FIG. 7, the user terminal 200 performs an access preparation process for remote access from the administrator terminal 100 through execution of the access file, screen-captures a user interface screen showing the access preparation process, compresses the capture file, and transmits the compressed capture file through HTTP.

The administrator terminal 100 transmits the identification information about the user terminal 200 to the web server 400, and thereby requests a capture screen corresponding to the identification information about the user terminal 200 from the web server 400 (S270). Then, the administrator terminal 100 receives the capture screen from the web server 400, and displays the capture screen on an administrator interface screen (S280).

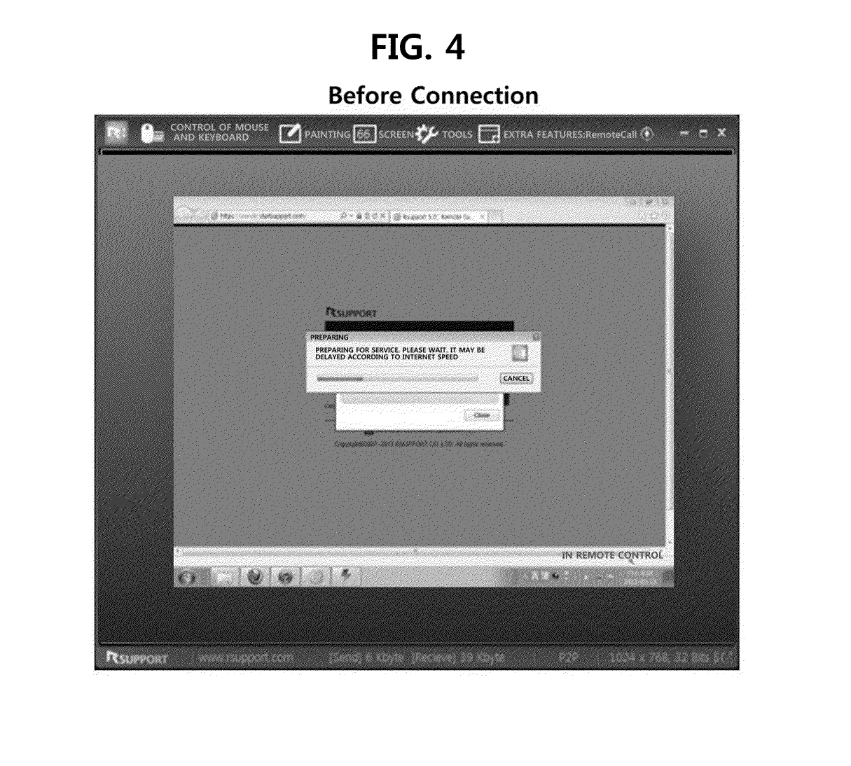

Referring to FIG. 4, a capture screen in which an access file execution process performed in the user terminal 200 is captured, is displayed on an interface screen of the administrator terminal 100. As shown in FIG. 4, even before remote access is completed, an administrator can check a file download and installation process for remote access to the user terminal 200 through the administrator terminal 100.

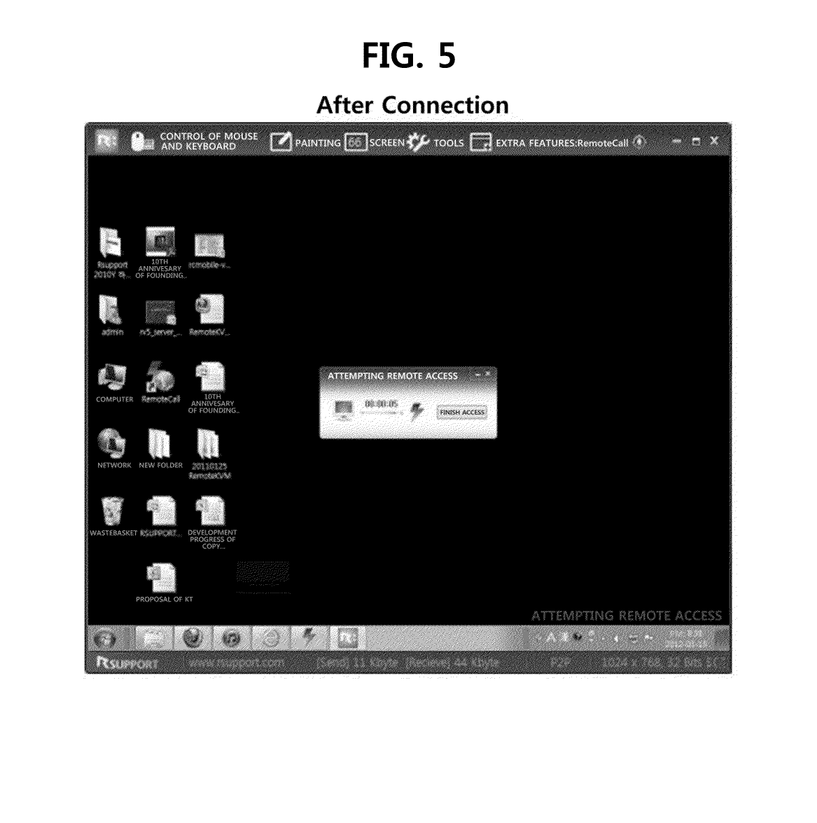

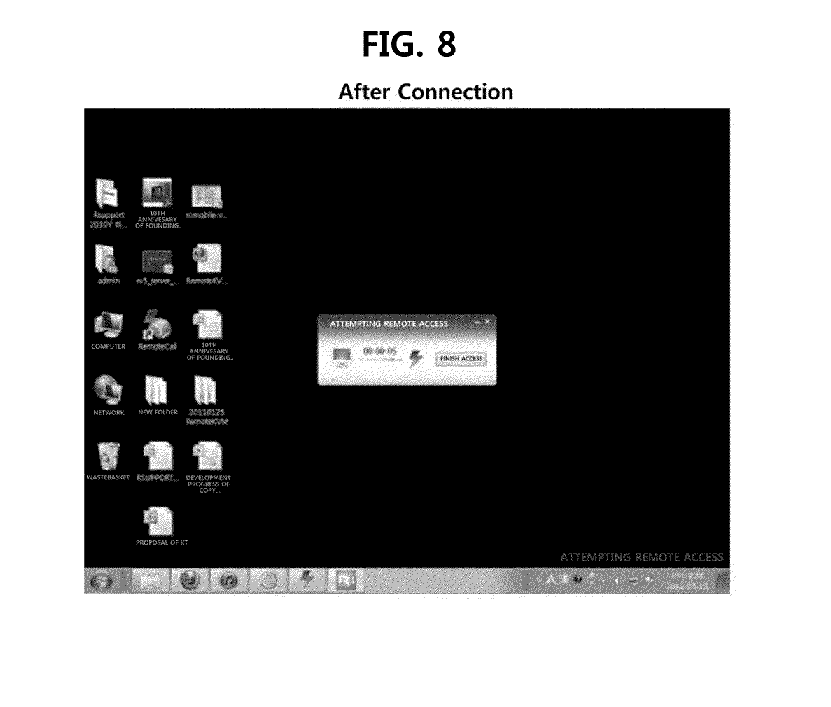

FIG. 5 and FIG. 8 show respective interface screens of the administrator terminal 100 and the user terminal 200 after the access file has been installed in the user terminal 200. In other words, a screen of the user terminal 200 is displayed on the interface screen of the administrator terminal 100.

FIG. 3 to FIG. 8 are merely examples of performing a remote access process according to an example embodiment of the present invention, and the present invention is not limited to the method of FIG. 3 to FIG. 8.

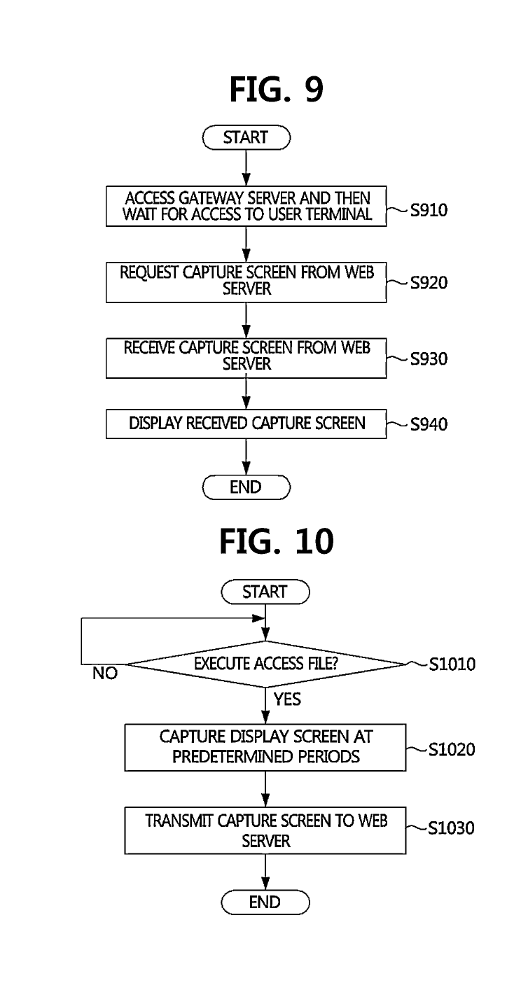

FIG. 9 is a flowchart illustrating a method for an administrator terminal to monitor a remote access process according to an example embodiment of the present invention.

Referring to FIG. 9, when a previously installed program is run, an administrator terminal transmits administrator identification information to an authentication server to perform authentication, and waits for access to a user terminal (S910).

Here, the administrator identification information may be an administrator ID, a password, etc. stored in advance in the authentication server. When authentication is completed, the administrator terminal may receive a URL, an access number, and session information (e.g., an IP address and port information) to be provided to a user from the authentication server.

Subsequently, the administrator terminal transmits identification information about the user terminal to a web server to request a capture screen corresponding to the identification information about the user terminal (S920), and receives a capture screen corresponding to the identification information about the user terminal from the web server (S930).

Here, capture screens may be continuously received from the web server until an access file execution process is completed in the user terminal.

Subsequently, the administrator terminal displays the capture screen received from the web server in step 930 on a screen interface so that an administrator can check the capture screen (S940).

Thus, in the method of monitoring a remote access process according to an example embodiment of the present invention, an administrator can check an access file execution process for remote access through a capture screen even before remote access is completed.

FIG. 10 is a flowchart illustrating a method for a user terminal to monitor a remote access process.

Description below will be made assuming that a user terminal has accessed an authentication server on the basis of a user input signal, and user identification information (e.g., an ID, a name, and an access number) has been input through the user terminal.

Referring to FIG. 10, a user terminal determines whether an access file provided from an authentication server is executed (S 1010).

When it is determined in step 1010 that the access file is executed, the user terminal screen-captures a screen interface showing a file execution process for remote access at predetermined periods (S 1020).

At this time, the user terminal may download and install a remote access module through execution of the access file, and actually execute the remote access module (check of a connection environment such as network authentication) before remote access is completed. Also, the user terminal may screen-capture a process of downloading and installing the remote access module after execution of the access file and actually executing the remote access module before completion of remote access. Here, the predetermined periods may be set by an administrator.

The user terminal compresses a screen captured in step 1020 and transmits the compressed capture screen with identification information about the user terminal to a web server (S1030). In other words, every time the file execution process for remote access is captured at the predetermined periods in step 1020, the user terminal may compress the capture screen and transmit the compressed capture screen with the identification information about the user terminal to the web server.

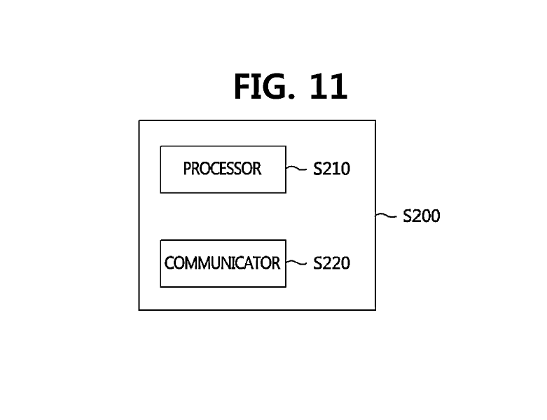

FIG. 11 is a block diagram showing a constitution of a user terminal according to an example embodiment of the present invention.

Referring to FIG. 11, a user terminal according to an example embodiment of the present invention may include a processor 210 and a communicator 220.

The processor 210 accesses an authentication server on the basis of a user input signal, and transmits user identification information to the authentication server.

Here, the user identification information may include user ID, name, access number, and so on.

After transmitting the user identification information to the authentication server, the processor 210 determines whether an access file is executed. When it is determined that an access file received from the authentication server is executed, the processor 210 captures a screen interface showing a file execution process for remote access at predetermined periods using the access file. Here, the predetermined periods may be set by an administrator.

The processor 210 may compress the capture screen and transmit the compressed capture screen with identification information (e.g., an access number) about the user terminal to a web server through the communicator 220.

The communicator 220 may transmit the capture screen and the identification information to the web server on the basis of control of the processor 210. At this time, the communicator 220 can transmit the capture screen to the web server through HTTP.

In the above-described method and system for monitoring remote access process according to an example embodiment of the present invention, a user terminal can capture and transmit its screen to a web server through HTTP when an access file for remote access is executed, and an administrator terminal can download the screen showing an access file execution process for remote access from the web server in real time for a check.

Consequently, an administrator can continuously monitor the remote access process of the user terminal through the administrator terminal on the basis of the captured screen, and check the screen of the user terminal as if remote access was complete even when remote access has not been completed.

While the example embodiments of the present invention and their advantages have been described in detail, it should be understood that various changes, substitutions and alterations may be made herein without departing from the scope of the invention.

What is claimed is:

1. A method of monitoring a remote access process performed in a controlled apparatus, the method comprising:
executing a downloaded access file;
running an application for remote access through execution of the access file, and capturing an entire interface screen of the controlled apparatus showing a remote access process at predetermined periods as soon as the application is run; and
transmitting the captured screen and identification information for identifying the controlled apparatus to a web server through hypertext transfer protocol (HTTP).

2. The method of claim 1, wherein transmitting the captured screen and the identification information to the web server through HTTP includes, when remote access from a control apparatus is completed, stopping transmission of the captured screen and the identification information for identifying the controlled apparatus to the web server through HTTP.

3. A method of monitoring a remote access process performed in a control apparatus, the method comprising:
accessing a gateway and waiting for remote access to a controlled apparatus;
while waiting for the remote access, transmitting identification information about the controlled apparatus to a web server, and requesting a capture screen of the controlled apparatus corresponding to the identification information; and
receiving the capture screen from the web server and displaying the received capture screen.

4. The method of claim 3, wherein the capture screen is an interface screen of the controlled apparatus obtained by screen-capturing the process before the remote access to the controlled apparatus is completed at predetermined periods.

5. A controlled apparatus, comprising:
a processor configured to execute a downloaded access file, and capture an entire interface screen of the controlled apparatus, which shows at least one of a network authentication process and a remote access module download process for remote access from a control apparatus, at predetermined periods through execution of the access file; and
a communicator configured to transmit the captured screen and an identifier for identifying the controlled apparatus to a web server through hypertext transfer protocol (HTTP) on the basis of control of the processor.

6. The controlled apparatus of claim 5, wherein when the remote access from the control apparatus is completed, the processor stops transmitting the captured screen and the identifier for identifying the controlled apparatus to the web server through HTTP.
